(19) United States
(12) Patent Application Publication
(10) Pub. No.: US 2009/0060399 A1
(43) Pub. Date: Mar. 5, 2009

(54) EASY-TEAR, NON-LAMINATED, POLYOLEFIN BASED POUCH AND METHOD OF FABRICATION

(76) Inventors: Roland Basque, Brossard (CA); Laurent Descamps, Montreal (CA); Sebastien Picard, Montreal (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/845,798

(22) Filed: Aug. 28, 2007

(51) Int. Cl. B65D 33/36; B31B 19/64

(52) U.S. Cl. 383/205; 493/189; 493/227

(57) ABSTRACT

An easy-tear, non-laminated, polyolefin based film pouch, method of manufacturing and forming die assembly is described. The pouch has a sealed flowable-type material containing compartment between opposed film walls which are sealed along opposed parallel edges thereof. A high tear strength seal tab is formed in a corner portion of the pouch and extends from one of the parallel edges. The seal tab is spaced a predetermined distance from an adjacent transverse side edge of the pouch. A tear slit is formed in the seal tab to initiate a tear in the pouch for access to the flowable material in the pouch. More specifically, but not exclusively, the pouch is fabricated in a vertical form, fill and seal (VFFS) machine.

### TECHNICAL FIELD

The present invention relates to an easy-tear, non-laminated, polyolefin based film pouch, a method of manufacturing the pouch and a tab/slit forming die assembly which forms a tab-shaped seal with a slit in a corner area of the pouch to provide easy access to the content of the pouch and prevent film pieces from being detached from the pouch when ripped open.

### BACKGROUND ART

It is known in the art to provide sealed packages with a notch or slit being formed in a side edge of a pouch contour seal whereby to provide access to the material inside the package or pouch. Such products have been popular in laminated thin flexible sheet material that are impervious to oxygen, moisture and other environmental elements. Many of these packages are constructed for packaging food products as well as all sorts of beauty products, oils, etc. Such film products are usually laminated with an aluminum coating to make them impervious to air. An example of such products is described in U.S. Pat. No. 2,542,206. Various other bags and pouches are also known and fabricated from plastic film sheet material and a typical example thereof is made with reference to U.S. Pat. No. 5,371,997. Again, with these types of products it is the intention to provide removal of a slit to facilitate the portion of the pouch to provide access to its content and such portions are usually discarded, and this pollutes the environment.

Another disadvantage of manufacturing such products with easy-tear notches or slits is that they cannot be manufactured at high speed and particularly on vertical form, fill and seal-type machines (VFFS) wherein a bag is formed from a film sheet filled with a product inserted therein and sealed and released as a finished product with its content, all in fast sequence. A problem with the formation of slits in a sealed area of thin film products is that often the area where the slit has been made will develop leaks in the seals formed during the manufacturing of the pouch. This is particularly so with VFFS-type machines where bags are formed, filled and sealed at high speeds below one second.

### SUMMARY OF INVENTION

It is therefore a feature of the present invention to provide an easy-tear, non-laminated, polyolefin based film pouch which substantially overcomes the above-mentioned disadvantages of the prior art.

Another feature of the present invention is to provide a method of fabricating an easy-tear, non-laminated, polyolefin based film pouch which substantially overcomes the above-mentioned disadvantages of the prior art.

A still further feature of the present invention is to provide a notch/slit forming die assembly for use in a VFFS-type machine to form a tab-shaped seal with a slit therein to provide easy access to the pouch content while preventing the removal of film pieces from the pouch.

Another feature of the present invention is to provide an easy-tear, non-laminated polyolefin based pouch with a sealed tab and tear slit and which can be manufactured at high speed on VFFS-type machines without stressing the pouch seals.

According to the above features, from a broad aspect, the present invention provides an easy-tear, non-laminated, polyolefin based film pouch. The pouch forms a sealed flowable-type material containing compartment between opposed film walls sealed along opposed parallel edges thereof. A seal tab is formed in a corner portion of the pouch and extends from one of the parallel edges. The seal tab is spaced a predetermined distance from an adjacent transverse side edge of the pouch containing a fused weld seal. A tear slit is formed in the seal tab to initiate a tear in the pouch for access to the flowable material in the pouch.

According to a further broad aspect of the present invention there is provided a method of fabricating an easy-tear, non-laminated, polyolefin based film pouch. The method comprises the steps of forming a film pouch with an open end through which a flowable-type material is to be inserted. The pouch has opposed side walls and sealed edges. The opposed side walls, in a corner portion of the pouch, are maintained juxtaposed in a creaseless manner. A seal tab is fused in the corner portion of the opposed side walls with a tab shaped die. The seal tab extends from one of the sealed edges. A tear slit is formed in the seal tab from the said one of the sealed edges and terminates spaced from an outer edge of the seal tab. A flowable-type material is then inserted in the pouch. The open end of the pouch is then sealed with a heat sealing element spaced a predetermined distance from the seal tab to prevent the formation of film creases in the area between the sealing element and the seal tab.

According to a still further broad aspect of the present invention there is provided a tab/slit forming die assembly for forming a tab-shaped seal with a slit therein in juxtaposed film side walls of a film pouch being formed and the tab extending from a seal edge thereof. The die assembly comprises a fixed backing plate having a U-shaped heating surface on a contact surface thereof. A displaceable die plate is secured to actuating biasing means. A tab shaped die is provided in the contact surface of the die plate and aligned with the U-shaped heating surface. The die plate is resiliently coupled to an intermediate slitting blade support plate by one or more compressible elements. The intermediate slitting blade support plate is rigidly connected to the actuating biasing means. A slitting blade is secured to a forward face of the slitting blade support plate and has a cutting free edge extending in a slot formed through the die plate and a portion of the tab shaped die and into the heating surface of the backing plate, wherein upon actuation of the actuating biasing means, a die closing force will first cause the die plate to close on the backing plate by the transfer of the force through the one or more compressible elements, and when arrested thereon to form a U-shaped seal band zone, the compressible elements will compress whereby the slitting blade support plate will move closer to the die support plate and cause the cutting free edge of the slitting blade to project through the slot in the tab shaped die and the heating surface of the backing plate to form a slit in the seal tab and spaced from said U-shaped seal band zone.

### BRIEF DESCRIPTION OF DRAWINGS

A preferred embodiment of the present invention will now be described with reference to the accompanying drawings in which:

FIG. 1 is a plan view of the easy-tear, non-laminated, polyolefin based film pouch formed in accordance with the present invention;

FIG. 2 is a fragmented view illustrating how the pouch is torn open along the tear slit in the seal tab;

FIG. 3 shows the bag having a corner portion thereof torn open to provide access to the flowable material inside the pouch with the corner portion retained by the bag;

FIG. 4A is a schematic view showing the easy-tear film pouch of the present invention being formed on a vertical form, fill and seal (VFFS) machine and showing the position of the die assembly relative to the horizontal sealing jaw;

FIG. 4B shows the pouch of FIG. 1 being released from the VFFS machine;

FIG. 5A is a side view showing the basic components of the tab/slit forming die assembly which is shown in position in FIG. 4A;

FIG. 5B is a top view showing the relationship between the U-shaped sealing resistive element and the slitting blade;

FIG. 6 is a cross-section view showing a film sheet being in a folded state to form a pouch in the VFFS machine; and

FIGS. 7A and 7B are fragmented side views of the film tube illustrating how the seal tab is displaced against the spreader fingers located inside the tube as the film tube is drawn thereover.

### DESCRIPTION OF PREFERRED EMBODIMENTS

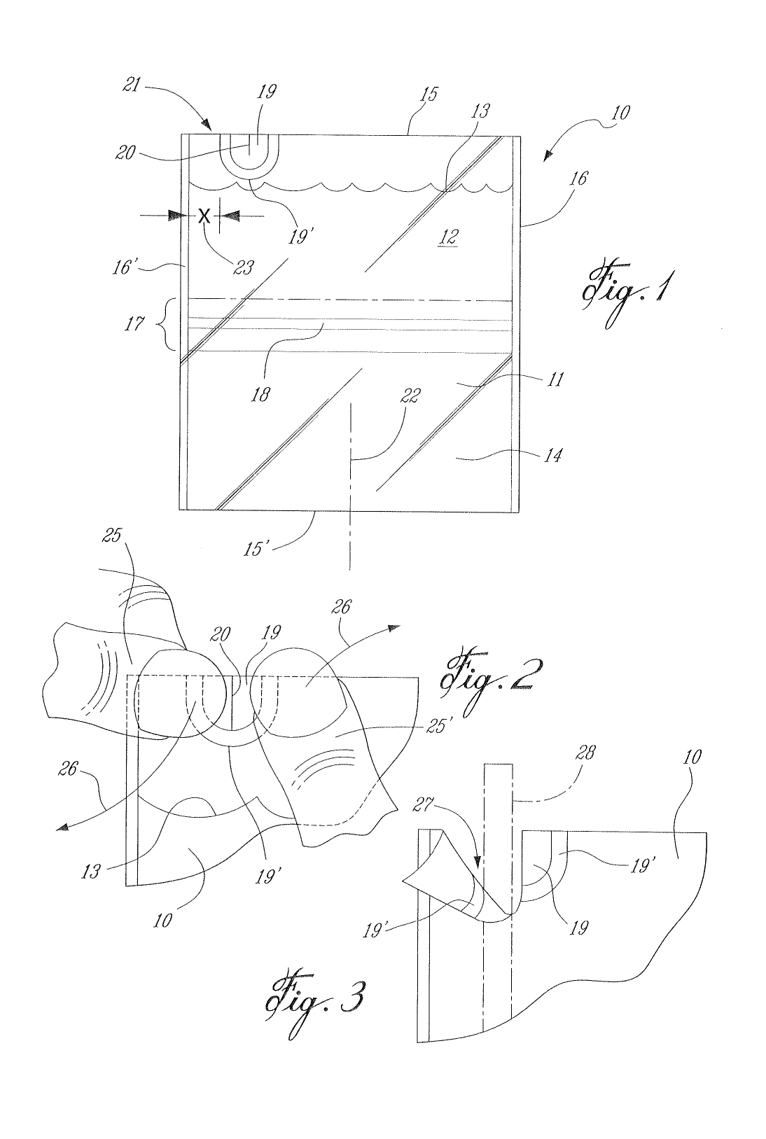

Referring now to the drawings and more particularly to FIGS. 1 to 3, there is shown generally at 10 the easy-tear film pouch of the present invention. It is fabricated from a non-laminated polyolefin based film 11 such as a linear low polyethylene film (LLPE). The pouch 10, as herein described, is made in a vertical form, fill and seal (VFFS) machine, schematically as shown in FIGS. 4 to 7B, but the invention is not intended to be restricted thereto as the pouch of FIG. 1 could conceivably be formed by other bag or pouch forming means.

The easy-tear film pouch 10 defines a flowable-type material containing compartment 12 therein to contain a flowable material, for example a liquid beverage 13, oils, powders, etc. The pouch has opposed film side walls 14 and 14′ which are juxtaposed and sealed along opposed parallel edges thereof. As hereinshown the pouch 10 is formed from a film sheet and defines opposed parallel bent edges 15 and 15′ and opposed parallel sealed edges 16 and 16′, the latter made by fusing. Accordingly, the pouch is sealed about its opposed parallel side edges. The pouch 10 as illustrated in FIG. 1 is further provided with an overlapped region 17 with a longitudinal heat seal 18 formed therealong to seal the two portions of the film sheet side walls 14 and 14′, together. This overlap and seal will be described later when describing the operation of the VFFS pouch forming machine.

The easy-tear film pouch 10 is further provided with a tear tab 19 delineated by a U-shaped sea zone 19′ formed spaced in a corner portion 21 of the pouch and extending from one of the parallel edges, herein the bent edge 15. A tear slit 20 is formed in the tear tab 19 to initiate a tear in the pouch through the seal zone 19′ for access to the flowable material 13 therein. The slit 20 as hereinshown may be oriented along a high tear strength axis when using oriented films, herein illustrated by axis 22. The tear tab 19 provides reinforcement about the slit to prevent accidental tearing or leaking about the slit.

As hereinshown the seal zone 19′ of the tear tab 19 is formed a predetermined distance “x” designated by reference numeral 23 from the fused seal edge 16′ and this distance is calculated to prevent the formation of pleats in the film edge seal in this area as such pleats usually cause perforation and leakages of the flowable material through the edge seal. The polyolefin film utilized in this embodiment is a linear low polyethylene (LLPE) film.

The seal zone 19′ is formed by fusing both side walls 14 and 14′ of the pouch together along a U-shaped pattern to provide a high tear strength tab and this further provides for control opening of the slit and prevent the detachment of film pieces in the corner portion 21 of the pouch during tearing. The slit 20 extends substantially centrally in the U-shaped tear tab 19 and extends from the folded edge 15 and terminates short of the bottom curved edge of the seal zone 19′ whereby the slit 20 is trapped in the seal tab and cannot accidentally be opened without applying a certain strength to do so. The corner portion 21 of the pouch also provides a finger grasping zone for ease of tearing the pouch along the tear slit, as illustrated in FIG. 2.

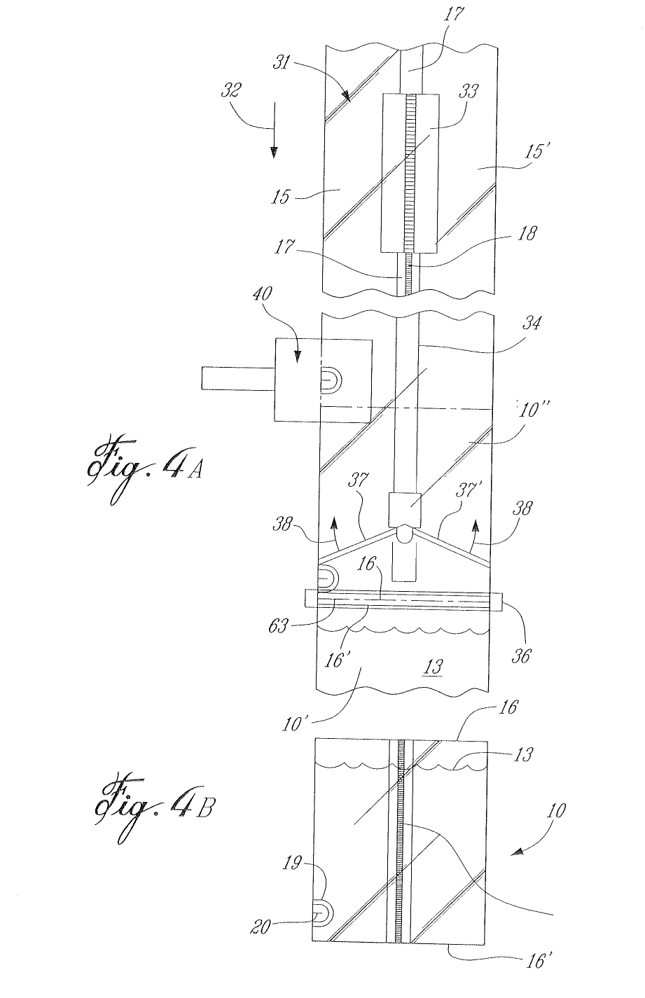

As shown in FIG. 2, in order to provide access to the pouch content, herein the liquid beverage 13 inside the pouch 10, a person pinches the corner portion 21 of the pouch with the fingers 25 of one hand and while holding the tear tab 19 on the other side of the tear slit 20 with the fingers 25′ of the other hand and performing a pulling action in opposed directions as indicated by arrows 26 and 26′. The tear slit 20 will direct the tear downwardly along the high tear axis 22 of the pouch until access is provided to the inside of the pouch, as illustrated in FIG. 3. The flowable liquid beverage 13 within the pouch is then accessible either by squeezing out the material through the created opening 27 or permitting the insertion of a straw 28, such as shown in phantom line in FIG. 3, to sip out the beverage. Of course, these pouches can be of different sizes and contain a variety of flowable products as above-described. This high tear strength tab therefore provides for controlled opening and sizing of the opening. If the tearing was easy, then the size of the opening during tearing could not be controlled and the film could create an uncontrollable opening and the liquid could flow out during the opening process with a film piece tearing away from the pouch causing the person to be soiled by the liquid and further causing pollution by a torn film piece. With this high tear strength tab once the product is removed from the pouch the entire pouch can easily be discarded in a recyclable manner. The use of these films also permits the pouch to be transparent whereby its content is accessible to the eye. It also permits for the pouch to be printed. The pouch could be sized from a mini-pouch wherein a refreshing liquid beverage can be provided up to a pouch of a few liters to provide larger volumes of the product.

Another advantage of the high tear strength tab and its location with respect to the pouch configuration is that when these pouches are formed in a Thimonnier-type VFFS machine, the filled pouches are dropped from the machine onto a hard surface and then conveyed away and dropped again in a collator and into cases or bags for transportation. Therefore, it is important that the seal zone 19′ of the tear tab be strong and that there not be any crease formations in the edge seals close to the tab to weaken the pouch to cause leakage when the liquid content is pressurized during these manipulations of the pouch.

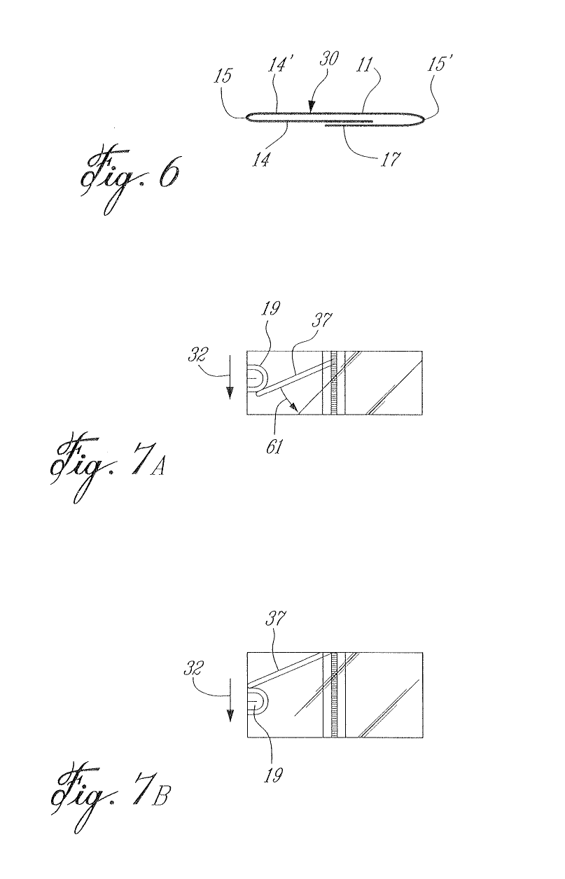

With reference now to FIGS. 4A to 7B, there will be described the method of fabricating the easy-tear, non-laminated polyolefin based film pouch 10 as previously described in a VFFS machine. FIG. 4A illustrates the pouch forming section of a VFFS-type machine and wherein a film sheet 30, as shown in FIG. 6, is folded to form the bent edges 15 and 15′ and then overlapped in the region 17 and sealed vertically. This forms a film tube 31 which is drawn in the machine in a downward direction as indicated by the arrow 32. The drawing of the film is arrested during fusing and slitting operations as well as during the formation of the seal zone 19′ which is synchronized with the horizontal sealing jaws. In a top part of this tube there is provided a vertical sealing jaw assembly 33 which seals the overlap portions together to form the fused seal 18, as previously mentioned. The film tube 31 is drawn about a filler tube 34 which is vertically supported and through which the flowable material is dispensed at a dispensing end 35 thereof.

The formed film tube then passes into a tab/slit forming die assembly 40 which will be described later and wherein the tear tab 19 is formed when the film is momentarily not in motion. This die assembly 10 is positioned at a precise location with respect to the horizontal sealing and slitting jaw assembly 36 to provide a method of locating the tab/slit on the pouch, herein only schematically illustrated. Inside the film tube there is also provided spreader fingers 37 and 37′ which are resiliently biased outwards in the direction of arrows 38 whereby to apply tension laterally across the film tube 31 to prevent the formation of creases therein, which is not desirable for sealing. Accordingly, the film tube 31 is maintained laterally taut as it is pulled through the die assembly 40.

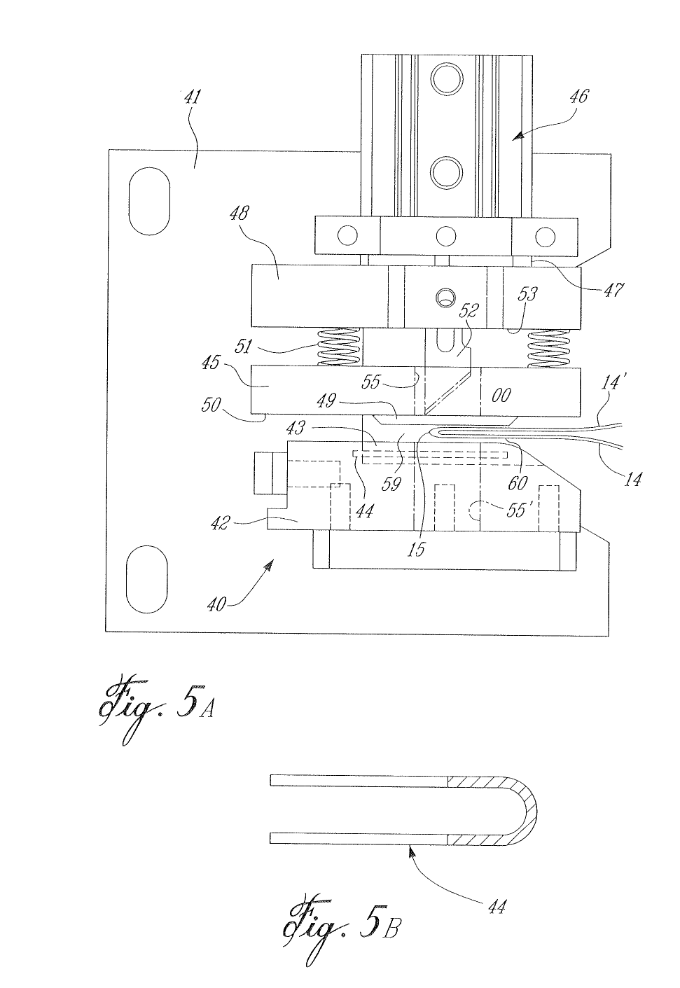

With reference now to FIGS. 5A and 5B, there is shown the construction of the tab/slit forming die assembly 40. It is supported by a support platform 41 at the location shown in FIG. 4A and it consists of a fixed backing plate 42 to which is secured a heating surface 43, usually formed of hard rubber material. As shown in FIG. 5B, a U-shaped resistive heating element 44 is conveniently disposed in the heating surface to provide a U-shaped configured heat zone 44′ by electrical impulses sent through the resistive heating element.

A displaceable flat die plate 45 is secured to actuating biasing means 46 which is herein in the form of a piston cylinder 47 which is secured to an intermediate slitting blade support plate 48. The displaceable die plate 45 has a circular-shaped die 49 projecting from the contact surface 50 thereof and aligned with the heating surface 43. The die plate 45 is resiliently coupled to the intermediate slitting blade support plate 48 by one or more compressible elements, herein four helical springs 55. The die 49 has a slat 55 therein for the passage of the slitting blade 52.

As shown in FIG. 5, the slitting blade 52 is secured to a forward face 53 of the slitting blade support plate 48. The blade has a cutting free edge 54 extending in the slot 55 formed through the die plate 45 and a portion of the circular-shaped die 49 and then into the heating surface 43 and the backing plate as herein identified by reference numeral 55′. The relationship of the blade 52 relative to the U-shaped heating element 44 is illustrated in FIG. 5B.

As also shown in FIG. 5A the die is in an open condition with a side edge portion of the film tube, this portion being illustrated herein and identified by reference numeral 60, extending within the opening 59 of the die which is positioned at a precise location with respect to the circular-shaped die 49 and heating surface 43. Upon actuation of the piston 46, the piston cylinder 47 will extend and cause the die plate 48 to close on the backing plate 42 by the transfer of the force through the compressible springs 51 and when the tab-shaped die 49 is arrested against the heating surface 43 with the film side walls held captive therebetween, the U-shaped seal zone 19′ of the tab 19 will be formed by fusing the opposed side walls of the film sheet together along a U-shaped band. As the spring force of the springs 51 is overcome by the piston force, the slitting blade support plate 48 will now move forwardly closer to the die support plate 45 and cause the cutting free edge 54 and a portion of the slitting blade to project through the slot 55 in the circular-shaped die and in the heating surface of the backing plates to form a slit in the tear tab. The film tube is arrested during the die closure and upon opening of the bag the film is advanced. It is pointed out that this entire sealing cycle of the die is effected in a piston stroke of half a second with 0.3 of a second being the time required to fuse the seal zone 19′.

At the same time the seal zone 19′ is formed by the die assembly 40 closing, the horizontal sealing and slitting jaw assembly is actuated to form the top seal 16′ for the filled pouch 10′ simultaneously forming the bottom seal 16 of the next pouch to be filled 10″ and slits the tube along slit lines 63, by gravity to release the filled pouch.

As the film tube 31 is drawn downwardly in the direction of arrow 32, it is drawn over the spreader fingers 37 and 37′ which maintain the film tube laterally stretched or under tension. As the film tube is drawn the seal zone 19′ will abut against one of the spreader fingers, herein spreader finger 37, as illustrated in FIG. 7A, and cause that spreader finger to move inwardly in the direction of arrow 61. Once the seal zone 19′ has passed by the finger 37, the finger will again resume its normal outwardly biased position, as illustrated in FIG. 7B. When reaching that position the horizontal sealing and slitting jaw assembly is actuated as well as the closing of the die assembly. At this particular position it is to be noted that the tear tab 19 is spaced slightly above the sealing jaw assembly 36. Because the film tube is maintained taut and because the U-shaped seal zone 19′ is positioned spaced from the bottom seal edge 16 and because the jaw is maintained closed on the film, no creases will be formed in the corner portion 21 of the pouch, as illustrated in FIG. 1. Therefore, it is also important to note that the die assembly 40 must be correctly positioned with respect to the horizontal sealing and slitting jaw assembly 36.

It is pointed out that with the VFFS machine the flowable product is continuously dispensed from the filler tube 34 during the closure of the horizontal sealing and slitting jaw assembly and as soon as the jaw closes the next bag to be filled 10′ already has material flowing therein. As the jaws open the filled pouch 10′ is dropped, as illustrated in FIG. 4B.

Briefly summarizing the method of fabricating the easy-tear, non-laminated, polyolefin based film pouch 10 of the present invention the method comprises the steps of forming the film pouch with an open end through which a flowable-type material is to be inserted. The opposed side walls of the film pouch are maintained juxtaposed in a creaseless manner in a corner portion thereof and a flat U-shaped seal zone 19′ is fused in this corner portion by fusing opposed side walls together with a U-shaped heating element 44. The flat tear tab thus produced extends from one of the edges. A tear slit is formed in the tear tab from one of the edges and terminates spaced from an outer edge of the U-shaped seal zone 19′. The slit is preferably, although not exclusively, oriented along a high tear strength axis of the film. A flowable type material is then inserted into the pouch and the open end of the bag is heat sealed a predetermined distance from the U-shaped seal zone 19′ to prevent the formation of film creases in the area between the horizontal sealing element and the tear tab.

More specifically the method of fabricating the easy-tear film pouch of the present invention is effected on a high speed VFFS machine as described hereinabove in detail whereby to produce the pouch as illustrated in FIG. 4B. The pouch illustrated in FIG. 4B is of a different size than the pouch as illustrated in FIG. 1 as it is much longer. By adjusting the position of the die assembly 40 with respect to the horizontal sealing and slitting jaw assembly and adjusting the machine parameters, bags of different sizes can be formed on the same VFFS machine.

It is within the ambit of the present invention to cover any obvious modifications of the preferred embodiment described herein provided such modifications fall within the scope of the appended claims.

We claim:

1. An easy-tear, non-laminated, polyolefin based film pouch, said pouch forming a sealed flowable-type material containing compartment between opposed film side walls sealed along opposed parallel edges thereof, a seal tab formed in a corner portion of said pouch and extending from one of said parallel edges, said seal tab being spaced a predetermined distance from an adjacent transverse side edge of said pouch containing a fused weld seal, and a tear slit formed in said seal tab to initiate a tear in said pouch for access to said flowable material in said pouch.

2. An easy-tear pouch as claimed in claim 1 wherein said seal tab is formed by a U-shaped seal band zone and wherein said slit extends from one of said parallel edges inside said U-shaped seal band zone and terminating spaced from said seal band zone whereby said slit is trapped in said seal tab.

3. An easy-tear pouch as claimed in claim 1 wherein said predetermined distance is calculated to prevent the formation of pleats in said film in said corner portion, said polyolefin based film being a linear low polyethylene (LLPE) film.

4. An easy-tear pouch as claimed in claim 1 wherein said tab is a high tear strength tab to provide for control opening along said slit and prevent the detachment of a film piece in said corner portion during tearing.

5. An easy-tear pouch as claimed in claim 1 wherein said pouch is formed by a form fill and seal process, two of said opposed parallel edges being opposed parallel folded straight edges and two of said opposed parallel edges being opposed parallel fused sealed straight edges, said tab extending from one of said folded straight edges.

6. An easy-Lear pouch as claimed in claim 5 wherein said pouch is further provided with an overlap film portion extending transversely thereacross from said sealed straight edges and disposed parallel to said folded straight edges, and a seal line interconnecting said overlap film portion.

7. An easy-tear pouch as claimed in claim 3 wherein said tab is a high tear strength tab, said corner portion provides a finger grasping zone for ease of tearing said pouch along said tear slit.

8. An easy-tear pouch as claimed in claim 1 wherein said flowable type material is a liquid material.

9. A method of fabricating an easy-tear, non-laminated, polyolefin based film pouch comprising the steps of:
i) forming a film pouch with an open end through which a flowable-type material is to be inserted, said pouch having opposed side walls and sealed edges;
ii) maintaining said opposed side walls in a corner portion of said pouch juxtaposed in a creaseless manner;
iii) fusing a seal tab in said corner portion of said opposed side walls with a tab forming die, said seal tab extending from said one of said sealed edges;
iv) forming a tear slit in said seal tab from said one of said sealed edges and terminating spaced from an outer sealed edge of said seal tab;
v) inserting said flowable-type material in said pouch; and
vi) sealing said open end with a heat sealing element spaced a predetermined distance from said seal tab to prevent the formation of film creases in the area between said sealing element and said seal tab.

10. A method as claimed in claim 9 wherein said method is effected in a vertical form, fill and seal (VFFS) machine, said step (i) comprising forming a film tube from a film sheet oriented vertically about a vertical liquid fill tube with longitudinal, vertically oriented, free edge portions of said film sheet overlapped to be sealed together along a seam line by vertical sealing jaws to form a film tube, said step (ii) comprising maintaining said film tube in a laterally stretched condition by resiliently biased spreader fingers disposed in an area above a dispensing end of said fill tube and biased against opposed bent over edges of said film tube, said tab forming die being disposed above said spreader fingers, said sealed edges being constituted by opposed vertical bent edges of said film tube.

11. A method as claimed in claim 10 wherein said tab forming die is provided with a heating plate and a die plate having said tab forming die, said plates being spaced from one another to form a passage therebetween, one of said plates being movable against the other plate, and slitting means associated with said die plate, said method further comprising the steps of positioning said die wherein a section of said opposed side walls adjacent one of said sealed bent over edges is received and displaced in said passage and aligned with said tab forming die whereupon when one of said plates is moved on said other plate with said film tube arrested, said seal tab is formed and sequentially a slit is formed by said slitting means.

12. A method as claimed in claim 11 wherein said step (vi) is formed simultaneously with said steps (iii) and (iv), said step (iv) being formed by horizontal sealing jaws disposed below said seal tab when engaged to form a top edge seal for a filled bag and a bottom edge seal for a next bag to be filled with a flowable product, said resiliently biased spreader fingers being disposed closely spaced above said seal tab for maintaining said opposed side walls in the area of said tear tab under tension during said sealing step (vi) to prevent said formation of film creases.

13. A method as claimed in claim 9 wherein said step (iii) comprises forming a high tear strength U-shaped fused band zone, said step (iv) comprising orienting said slit centrally in said U-shaped seal band zone.

14. A tab/slit forming die assembly for forming a tab-shaped seal with a slit therein in juxtaposed film side walls of a film pouch being formed from a seal edge of said pouch, said die assembly comprising a fixed backing plate having a U-shaped heating surface on a contact surface thereof, a displaceable die plate secured to actuating biasing means, a tab shaped die in a contact surface of said die plate and aligned with said U-shaped heating surface, said die plate being resiliently coupled to an intermediate slitting blade support plate by one or more compressible elements, said intermediate slitting blade support plate being rigidly connected to said actuating biasing means, a slitting blade secured to a forward face of said slitting blade support plate and having a cutting free edge extending in a slot formed through said die plate and a portion of said tab shaped die and into said heating surface of said backing plate wherein upon actuation of said actuating biasing means a die closing force will first cause said die plate to close on said backing plate by the transfer of said force through said one or more compressible elements and when arrested thereon to form a U-shaped seal band zone, said compressible elements will compress whereby said slitting blade support plate will move closer to said die support plate and cause said cutting free edge of said slitting blade to project through said slot in said tab shaped die and said heating surface of said backing plate to form a slit in said seal tab and spaced from said U-shaped seal band zone.

15. A forming die as claimed in claim 14 wherein said actuating biasing means is a piston cylinder, said piston cylinder having a stroke speed of about 0.5 seconds wherein said seal is formed during a time of about 0.3 seconds.

16. A forming die as claimed in claim 14 wherein said tab forming die is a silicon die, said heating surface being a hard rubber surface with an impulse heating, seal forming, U-shaped resistive element therein, and impulse generating means synchronized to said actuating biasing means.

17. A forming die as claimed in claim 14 wherein said tab forming forms said U-shaped seal band zone from said sealed edge and into said juxtaposed film side walls, said slit being a straight slit extending into said U-shaped seal band zone from said sealed edge and terminating spaced from a bottom edge of said U-shaped seal band zone.
